(19) United States
(12) Patent Application Publication
(10) Pub. No.: US 2026/0349912 A1
(43) Pub. Date: Nov. 5, 2026

(54) END-TO-END AUTOMATED REMOTE CHECK DEPOSIT TESTING ECOSYSTEM

(71) Applicant: Bank of America Corporation, Charlotte, NC (US)

(72) Inventors: Priyank Varshney, Huntersville, NC (US); Pavan Chayanam, Alamo, CA (US); Eugene Butsko, Fort Mill, SC (US); Navdeep Mahajan, Indian Land, SC (US)

(21) Appl. No.: 19/196,981

(22) Filed: May 2, 2025

(51) Int. Cl. G06F 11/3668; G06F 11/34; G06Q 20/04; G06Q 40/02

(52) U.S. Cl. CPC G06F 11/3696; G06F 11/3457; G06F 11/3684; G06Q 20/042; G06Q 40/02

(57) ABSTRACT

Systems and methods for automated remote check deposit testing are provided. A method may include receiving, at a check generation module, a plurality of configuration parameters, and generating a test file set. The method may include converting the test file set to a base 64 encoded string and transmitting the base 64 encoded string to a runtime test module. The method may include simulating, via the runtime test module, a remote check deposit at a remote check deposit application by initializing the remote check deposit application, providing deposit details requested by the remote check deposit application, and transmitting the base 64 encoded string to the remote check deposit application. The method may include determining a success status of the simulated remote check deposit, compiling a test report based on the success status, and automatically displaying a graphical representation of the configuration parameters in conjunction with the test report.

### FIELD OF TECHNOLOGY

Aspects of the disclosure relate to digital systems. Specifically, aspects of the disclosure relate to automated testing systems.

### BACKGROUND OF THE DISCLOSURE

Remote check deposit, also known as mobile deposit or remote deposit capture, has become an increasingly common method for consumers and businesses to deposit checks using smartphones, tablets, or scanners. This technology relies on users capturing images of physical checks and submitting them electronically to financial institutions. As the usage of remote check deposit expands, ensuring the accuracy, reliability, and regulatory compliance of the systems involved has become critically important.

Traditionally, testing remote deposit systems has required extensive manual effort. Quality assurance teams must simulate a wide variety of real-world scenarios—including different check formats, image qualities, lighting conditions, and deposit workflows. This process is not only time-consuming and labor-intensive, but it is also prone to inconsistencies and errors due to the subjective nature of manual testing.

Moreover, as banks and financial institutions frequently update their mobile apps and backend systems, testing must be repeated regularly to verify continued compliance and functionality. The lack of a standardized, automated testing solution hampers development and introduces the risk of undetected issues reaching production. It would be desirable, therefore, to provide systems and methods for end-to-end automated testing for remote check deposit.

### SUMMARY OF THE DISCLOSURE

Aspects of the disclosure relate to systems and methods for automated remote check deposit testing. A system may include a check generation module. The check generation module may include a processor and computer executable instructions stored in a non-transitory memory that, when run on the processor, may be configured to implement system features.

The system may be configured to receive a plurality of configuration parameters. The system may be configured to generate a test file set. The test file set may include a first image file representing a scanned image of a check front and a second image file representing a scanned image of a check back.

The system may be configured to convert the test file set to a base 64 encoded string. The system may be configured to transmit the base 64 encoded string to a runtime test module to simulate a remote check deposit at a remote check deposit application. To perform the simulation, the runtime test module may be configured to initialize the remote check deposit application, provide deposit details requested by the remote check deposit application, and transmit the base 64 encoded string to the remote check deposit application.

The system may be configured to determine a success status of the simulated remote check deposit. The system may be configured to compile a test report based on the success status. The system may be configured to automatically display, on a display associated with an administrator of the system, a graphical representation of the configuration parameters in conjunction with the test report.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 shows an illustrative system in accordance with principles of the disclosure;

FIG. 2 shows an illustrative apparatus in accordance with principles of the disclosure;

FIG. 3 shows an illustrative flowchart in accordance with principles of the disclosure;

FIG. 4 shows another illustrative flowchart in accordance with principles of the disclosure; and

FIG. 5 shows an illustrative diagram in accordance with principles of the disclosure.

### DETAILED DESCRIPTION OF THE DISCLOSURE

Aspects of the disclosure relate to systems and methods for automated remote check deposit testing. System features and configurations may, in certain embodiments, correspond to steps of the methods. The system may include a processor and computer executable instructions stored in a non-transitory memory that, when run on the processor, may be configured to implement system features or execute method steps.

Systems may include a check generation module. The system may be configured to receive a plurality of configuration parameters. The system may be configured to generate a test file set. The test file set may include a first image file representing a scanned image of a check front and a second image file representing a scanned image of a check back. The image files in the test file set may be in jpg (Joint Photographic Experts Group) file format.

The system may be configured to convert the test file set to a base 64 encoded string. A base 64 encoded string may be a text representation of binary data resulting from a conversion of binary data (e.g., images or audio) into a sequence of ASCII characters (including uppercase letters (A-Z), lowercase letters (a-z), numbers (0-9), and the symbols “+” and “/”).

The system may be configured to transmit the base 64 encoded string to a runtime test module to simulate a remote check deposit at a remote check deposit application. In some embodiments, the runtime test module may include an Appium testing tool.

To perform the simulation, the runtime test module may be configured to initialize the remote check deposit application. This remote check deposit application may include a mobile application that is associated with a financial institution. Initializing the remote check deposit application may include providing account and/or security information (e.g., username, email, password, security questions, etc.) to open and successfully log in to the remote check deposit application.

To perform the simulation, the runtime test module may be configured to provide deposit details requested by the remote check deposit application. Deposit details may, for example, include an account number for a “deposit to” account, a deposit amount, a name of the entity to which the check is addressed, and/or any other relevant information the remote check deposit application may request in the process of a remote check deposit.

To perform the simulation, the runtime test module may be configured to transmit the base 64 encoded string to the remote check deposit application. The remote check deposit application may, in certain embodiments, be configured to accept a base 64 encoded string as part of a real check deposit. The base 64 encoded string when part of a real check deposit may be a string representation of images of the checks as captured by a device camera.

When using an Appium tool, runtime test module may leverage certain Appium testing capabilities. For example, the runtime test module may utilize “processArguments” for an iOS-based remote deposit application (with this command, the base64 encoded string may be passed as an app launch argument to the iOS app). The runtime test module may utilize “optionalIntentArguments” for an Android-based remote deposit application (with this command, the base64 encoded string may be passed as an additional intent argument to start the app launch activity).

The system may be configured to determine a success status of the simulated remote check deposit. The success status may be a binary pass/fail. In some embodiments, the success status may include a more nuanced score (e.g., 0-100).

The system may be configured to compile a test report based, at least in part, on the success status. The test report may present the success status. The test report may present the success status along with additional information for context. The additional information may, for example, include the configuration parameters. The additional information may include analysis of the test and may provide information about what went wrong or what went right. The additional information may include a compartmentalization of different elements of the check images, and provide feedback on which aspect of the check may have caused a failure. The system may use generative AI to compile the test report. The test report may analyze a series of check deposits and/or check deposit tests, and generate the report based on the analysis.

The system may be configured to automatically display, on a computer display associated with an administrative account in the system, a graphical representation of the configuration parameters in conjunction with the test report. The graphical representation may, for example, include a listing of the configuration parameters, next to a rendering of the images of the test file which were generated based on the configuration parameters, next to the test report. This graphical representation clearly connects the inputs to the test files created by the inputs to the test results from those test file—thereby enhancing the testing tool into something a user can easily digest and leverage.

In certain embodiments, configuration parameters may include numerical check amount, text-based check amount, depositor name, deposit recipient, routing number, and/or account number. The configuration parameters may also include an address of the depositor, a “pay for” entry, and/or a check number.

The configuration parameters may include a deposit endorsement. The deposit endorsement parameter may include details such as position and quality of an endorsement signature, whether the signature matches the depositor name, whether the endorsement includes a remote deposit indicator, and/or what such indicator may include (e.g., check box, text of the indicator, etc.).

The configuration parameters may include check type. Check type may be selected from a list that may include handwritten personal check, cashier's check, certified check, and/or traveler's check.

The configuration parameters may include check quality. Check quality may include a check scan quality. Check scan quality may include a blurriness index. Check scan quality may include a positioning index. The positioning index may include a distance, rotation, and/or tilt.

When the check type is a handwritten personal check, check quality may include a handwriting quality. Handwriting quality may include multiple levels. There may be two levels, such as good vs poor. In some embodiments there may be additional levels (e.g., scale of 1-5 or 1-10, or any other suitable way of describing a level of handwriting quality). The handwriting quality may also include a handwriting “type” component (e.g., large, small, round, loopy, angular, etc.).

In some embodiments, the check generation module may include an artificial intelligence (AI) model. The AI model may be configured to generate the test file set based on the configuration parameters. Leveraging an AI model may facilitate that the system is able to generate a wide variety of test check images, and in particular, test images that best represent edge cases, thereby enhancing the test capabilities of the system as well as the ability of the system to identify and correct deficiencies in the remote deposit application.

In certain embodiments, the AI model may be trained on a set of test data that includes historical images of checks that were erroneously rejected by a check deposit application.

When using AI, the system may be trained to take as input (that includes the configuration parameters) an unstructured text-based query (i.e., the user can free-write and input) that describes the desired parameters for the test.

In some embodiments, when the success status of the simulated remote check deposit is negative, the system may be configured to generate a recommended update for the remote check deposit application. The update may be based, at least in part, on the configuration parameters associated with the test file that resulted in the negative success status.

Generating the recommended update may utilize an AI model. Generating the recommended update may include identifying the configuration parameter that caused or contributed to the failure. For example, in a case with 5 parameters, a first test may have been successful with one setup of the 5 parameters, and a second test may have only changed one if the parameters which led to a failure. This may indicate that the changed parameter led to failure, and the recommended update may update the remote check deposit application to clear the deposit even when that one parameter is in a state that led to failure in the second test.

The system may be configured to apply the recommended update. After application of the recommended update, the system may be configured to re-simulate the remote check deposit at the remote check deposit application. The system may re-simulate the deposit using the same base 64 string previously generated, to keep the process efficient while testing the updated remote check deposit application.

Apparatus and methods described herein are illustrative. Apparatus and methods in accordance with this disclosure will now be described in connection with the figures, which form a part hereof. The figures show illustrative features of apparatus and method steps in accordance with the principles of this disclosure. It is understood that other embodiments may be utilized, and that structural, functional, and procedural modifications may be made without departing from the scope and spirit of the present disclosure.

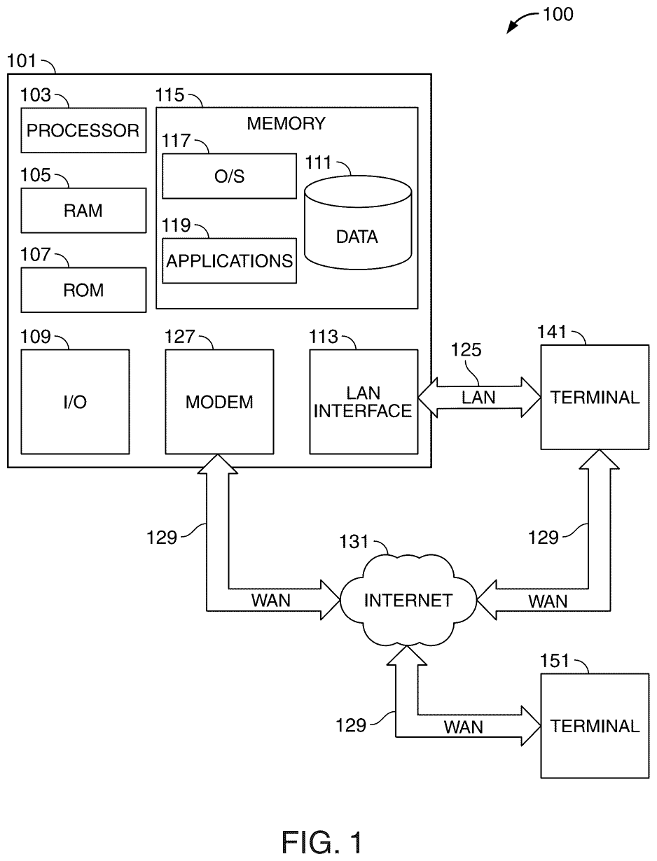

FIG. 1 shows an illustrative block diagram of system 100 that includes computer 101. Computer 101 may alternatively be referred to herein as a “server” or a “computing device.” Computer 101 may be a workstation, desktop, laptop, tablet, smart phone, or any other suitable computing device. Elements of system 100, including computer 101, may be used to implement various aspects of the systems and methods disclosed herein.

Computer 101 may have a processor 103 for controlling the operation of the device and its associated components, and may include RAM 105, ROM 107, input/output module 109, and a memory 115. The processor 103 may also execute all software running on the computer—e.g., the operating system and/or voice recognition software. Other components commonly used for computers, such as EEPROM or Flash memory or any other suitable components, may also be part of the computer 101.

The memory 115 may comprise any suitable permanent storage technology—e.g., a hard drive. The memory 115 may store software including the operating system 117 and application(s) 119 along with any data 111 needed for the operation of the system 100. Memory 115 may also store videos, text, and/or audio assistance files. The videos, text, and/or audio assistance files may also be stored in cache memory, or any other suitable memory. Alternatively, some or all of computer executable instructions (alternatively referred to as “code”) may be embodied in hardware or firmware (not shown). The computer 101 may execute the instructions embodied by the software to perform various functions.

Input/output (“I/O”) module may include connectivity to a microphone, keyboard, touch screen, mouse, and/or stylus through which a user of computer 101 may provide input. The input may include input relating to cursor movement. The input may relate to remote check deposit. The input/output module may also include one or more speakers for providing audio output and a video display device for providing textual, audio, audiovisual, and/or graphical output. The input and output may be related to computer application functionality. The input and output may be related to remote check deposit.

System 100 may be connected to other systems via a local area network (LAN) interface 113.

System 100 may operate in a networked environment supporting connections to one or more remote computers, such as terminals 141 and 151. Terminals 141 and 151 may be personal computers or servers that include many or all of the elements described above relative to system 100. The network connections depicted in FIG. 1 include a local area network (LAN) 125 and a wide area network (WAN) 129, but may also include other networks. When used in a LAN networking environment, computer 101 is connected to LAN 125 through a LAN interface or adapter 113. When used in a WAN networking environment, computer 101 may include a modem 127 or other means for establishing communications over WAN 129, such as Internet 131.

It will be appreciated that the network connections shown are illustrative and other means of establishing a communications link between computers may be used. The existence of various well-known protocols such as TCP/IP, Ethernet, FTP, HTTP and the like is presumed, and the system can be operated in a client-server configuration to permit a user to retrieve web pages from a web-based server. The web-based server may transmit data to any other suitable computer system. The web-based server may also send computer-readable instructions, together with the data, to any suitable computer system. The computer-readable instructions may be to store the data in cache memory, the hard drive, secondary memory, or any other suitable memory.

Additionally, application program(s) 119, which may be used by computer 101, may include computer executable instructions for invoking user functionality related to communication, such as e-mail, Short Message Service (SMS), and voice input and speech recognition applications. Application program(s) 119 (which may be alternatively referred to herein as “plugins,” “applications,” or “apps”) may include computer executable instructions for invoking user functionality related to performing various tasks. The various tasks may be related to remote check deposit.

Computer 101 and/or terminals 141 and 151 may also be devices including various other components, such as a battery, speaker, and/or antennas (not shown).

Terminal 151 and/or terminal 141 may be portable devices such as a laptop, cell phone, Blackberry™, tablet, smartphone, or any other suitable device for receiving, storing, transmitting and/or displaying relevant information. Terminals 151 and/or terminal 141 may be other devices. These devices may be identical to system 100 or different. The differences may be related to hardware components and/or software components.

Any information described above in connection with database 111, and any other suitable information, may be stored in memory 115. One or more of applications 119 may include one or more algorithms that may be used to implement features of the disclosure, and/or any other suitable tasks.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, mobile phones, smart phones and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc., that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

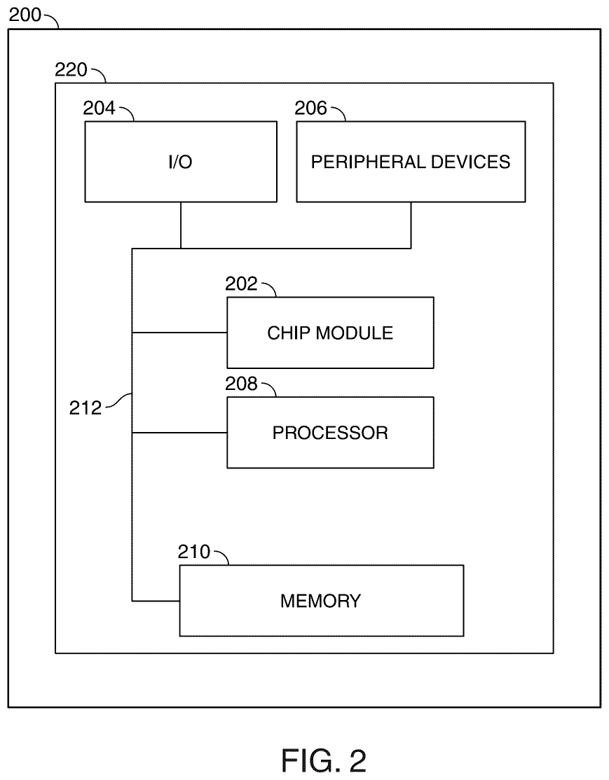

FIG. 2 shows illustrative apparatus 200 that may be configured in accordance with the principles of the disclosure. Apparatus 200 may be a computing machine. Apparatus 200 may include one or more features of the apparatus shown in FIG. 1. Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device or any other suitable media or devices; peripheral devices 206, which may include counter timers, real-time timers, power-on reset generators or any other suitable peripheral devices; logical processing device 208, which may compute data structural information and structural parameters of the data; and machine-readable memory 210.

Machine-readable memory 210 may be configured to store in machine-readable data structures: machine executable instructions (which may be alternatively referred to herein as “computer instructions” or “computer code”), applications, signals, and/or any other suitable information or data structures.

Components 202, 204, 206, 208 and 210 may be coupled together by a system bus or other interconnections 212 and may be present on one or more circuit boards such as 220. In some embodiments, the components may be integrated into a single chip. The chip may be silicon-based.

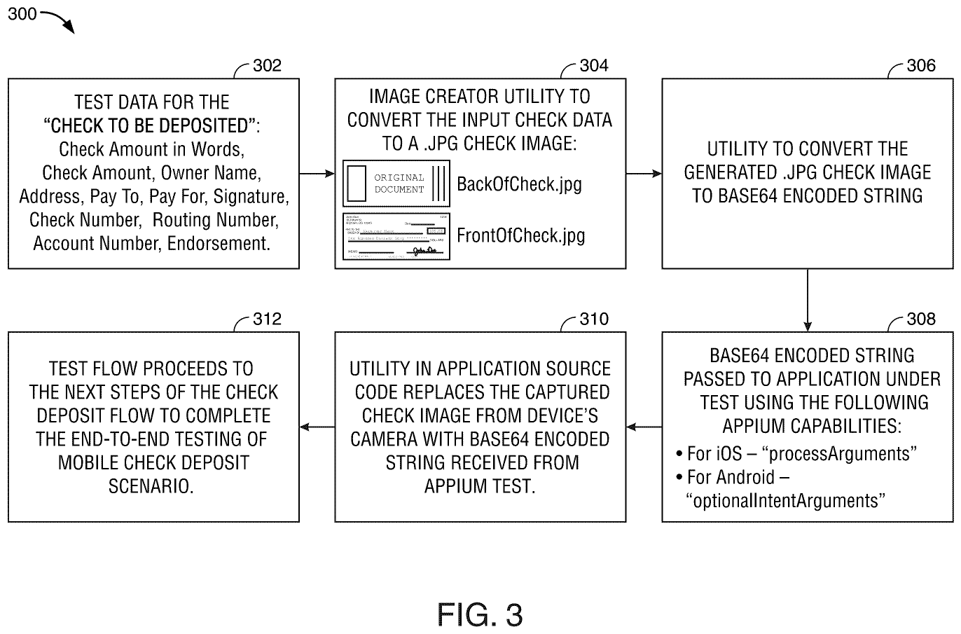

FIG. 3 shows illustrative flowchart 300 in accordance with principles of the disclosure. Steps of flowchart 300 may correspond to method steps and/or system features and configurations.

At step 302, test data may be inputted and/or received for the simulated check to be deposited. Test data may include parameters that may include check amount in words, check amount in numbers, owner (i.e., depositor) name, address, pay to, pay for, signature, check number, routing number, account number, and/or endorsement.

At step 304, the Image Creator utility (which may, in certain embodiments, corresponds to the check generation module) may convert the input check data to a .jpg check image, which may include a file for the front of the check and a file for the back of the check.

At step 306, the system (which may be alternatively referred to as a utility) may convert the generated .jpg check image to base 64 encoded string.

At step 308, the base 64 encoded string may be passed to a remote deposit application under test via a runtime test module. The runtime test module may include an Appium tool that may leverage certain Appium testing capabilities. For example, the runtime test module may utilize “processArguments” for an iOS-based remote deposit application. The runtime test module may utilize “optionalIntentArguments” for an Android-based remote deposit application.

At step 310, the system may insert, in application source code, the base 64 encoded string in the workstream of the remote deposit application in place of a captured check image from device's camera.

At step 312, the test flow may proceed to the next steps of the check deposit flow to complete the end-to-end testing of a mobile check deposit scenario.

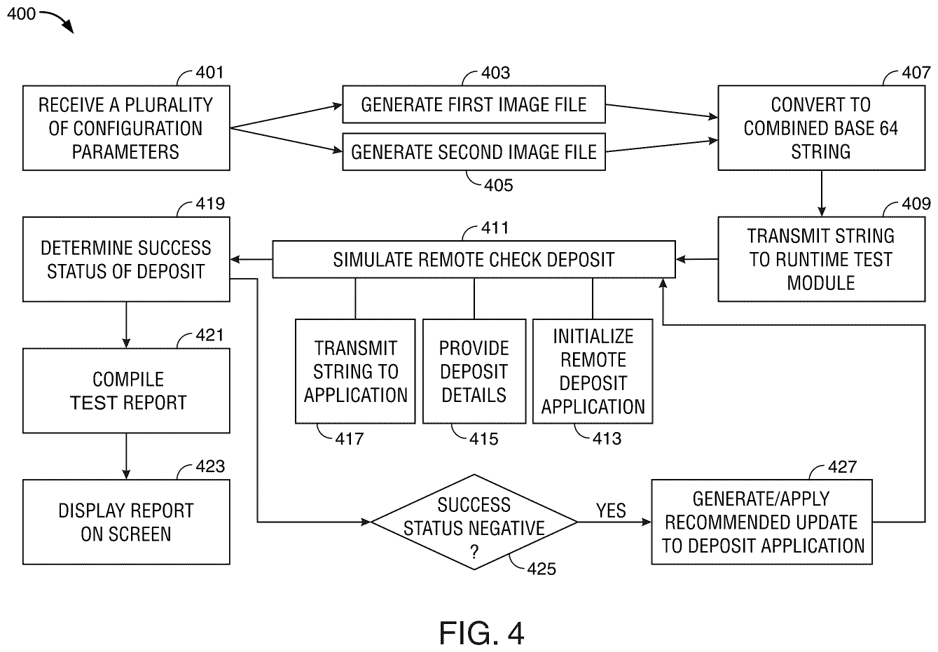

FIG. 4 shows illustrative flowchart 400 in accordance with principles of the disclosure. Steps of flowchart 400 may correspond to method steps and/or system features and configurations.

At step 401 the system may receive a plurality of configuration parameters. At step 403 the system may generate a first image file. At step 405 the system may generate a second image file. The first image file may correspond to the front of a check and the second image file may correspond to the back of check, both of which may be generated based on the configuration parameters. The first and second image files may be part of a combined test file.

At step 407 the system may convert the first and second image files of the test file into a base 64 string. The base 64 string may include a combination of the first and second image files. The base 64 string may include additional information that may be relevant to or used in a check deposit.

At step 409 the system may transmit the string to a runtime test module. At step 411 the module may facilitate a simulated remote check deposit. The simulated check deposit may include an automated process that includes initializing a remote deposit application (413), providing deposit details (415), and transmitting the string to the remote deposit application (417).

At step 419, the system may determine a success of the deposit. At step 421 the system may compile a test report. At 423, the system may display the report on a screen. The screen may be associated with a system administrator. The report displayed may include a graphical representation of the configuration parameters.

At step 425 the system may query if the success status was negative. This query may be performed (as shown) in parallel to compilation and display of the test report (i.e., steps 421-423). In some embodiments, the query may be performed subsequent to compilation and display of the test report (i.e., steps 421-423).

If system determines that the success status was negative, the system may, at step 427, generate a recommended update and/or apply the update to the remote deposit application. After the update at step 427, the system may rerun the test and proceed to step 411. Proceeding directly to step 411 may eliminate the need to regenerate the base 64 encoded string. In some embodiments, it may be advantageous to regenerate the string (e.g., in case the same inputs may be associated with various outputs, such as in the case where AI is utilized in generating the test files based on the configuration parameter inputs), and the system may loop back to an earlier stage (e.g., 403) after the update.

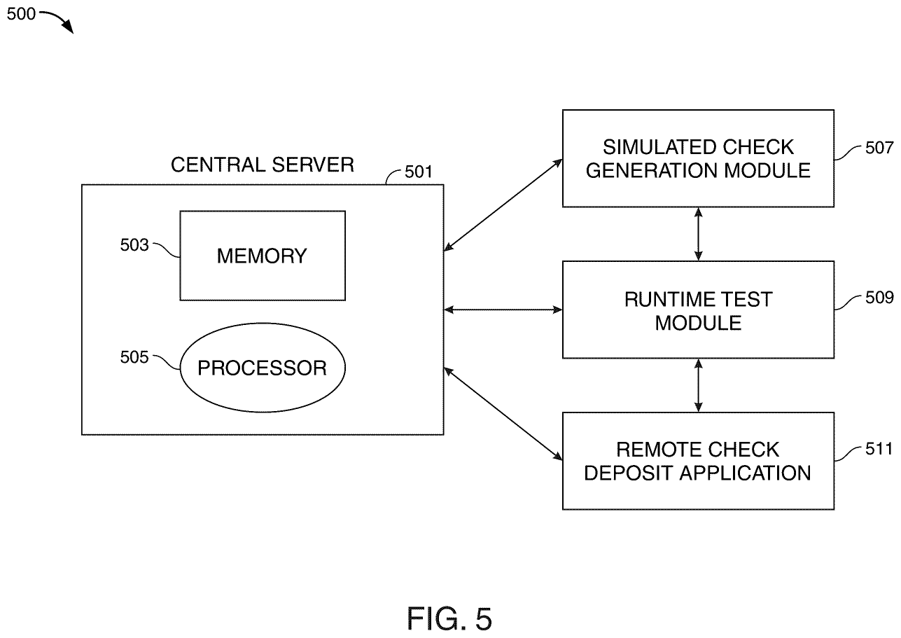

FIG. 5 shows illustrative diagram 500 in accordance with principles of the disclosure. Diagram 500 may show components of an illustrative system. The system may include a central server 501 that may include memory 503 and processor 505.

The system may include simulated check generation module 507, runtime test module 509, and remote check deposit application 511. In certain embodiment, check generation module 507 may be included in or located at central server 501.

Components 501, 507, 509, and 511 may be interconnected to facilitate communication between the components, as needed to accomplish the system features and method steps as described elsewhere herein.

The steps of methods may be performed in an order other than the order shown and/or described herein. Embodiments may omit steps shown and/or described in connection with illustrative methods. Embodiments may include steps that are neither shown nor described in connection with illustrative methods.

Illustrative method steps may be combined. For example, an illustrative method may include steps shown in connection with another illustrative method.

Apparatus may omit features shown and/or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

The drawings show illustrative features of apparatus and methods in accordance with the principles of the invention. The features are illustrated in the context of selected embodiments. It will be understood that features shown in connection with one of the embodiments may be practiced in accordance with the principles of the invention along with features shown in connection with another of the embodiments.

One of ordinary skill in the art will appreciate that the steps shown and described herein may be performed in other than the recited order and that one or more steps illustrated may be optional. The methods of the above-referenced embodiments may involve the use of any suitable elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

Thus, methods and systems for end-to-end automated remote check deposit testing ecosystems are provided. Persons skilled in the art will appreciate that the present invention can be practiced by other than the described embodiments, which are presented for purposes of illustration rather than of limitation, and that the present invention is limited only by the claims that follow.

What is claimed is:

1. A method for automated remote check deposit testing, the method run via computer executable instructions stored in a non-transitory memory and running on a processor, the method comprising:
receiving, at a check generation module, a plurality of configuration parameters;
generating, at the check generation module, a test file set comprising a first image file representing a scanned image of a check front and a second image file representing a scanned image of a check back;
converting the test file set to a base 64 encoded string;
transmitting the base 64 encoded string to a runtime test module;
simulating, via the runtime test module, a remote check deposit at a remote check deposit application, comprising:
initializing the remote check deposit application;
providing deposit details requested by the remote check deposit application; and
transmitting the base 64 encoded string to the remote check deposit application;
determining a success status of the simulated remote check deposit;
compiling a test report based on the success status; and
automatically displaying, on a display of an administrator computer system, a graphical representation of the configuration parameters in conjunction with the test report.

2. The method of claim 1 wherein the configuration parameters comprise numerical check amount, text-based check amount, depositor name, deposit recipient, routing number, and account number.

3. The method of claim 1 wherein the configuration parameters comprise check type, and wherein check type is selected from a list comprising handwritten personal check, cashier's check, certified check, and traveler's check.

4. The method of claim 1 wherein the configuration parameters comprise check quality, and wherein:
check quality comprises a check scan quality that comprises a blurriness index and a positioning index, wherein the positioning index comprises a distance, rotation, and tilt; and
when the test file set simulates a handwritten check, check quality comprises a handwriting quality.

5. The method of claim 1 wherein the configuration parameters comprise a deposit endorsement, wherein the deposit endorsement parameter comprises:
a position and quality of an endorsement signature of an endorsement;
whether a name in the endorsement signature matches a depositor name; and
whether the endorsement includes a remote deposit indicator.

6. The method of claim 1 wherein the check generation module comprises an artificial intelligence (AI) model that is configured to generate the test file set based on the configuration parameters.

7. The method of claim 6 wherein the AI model is trained on a set of test data that includes historical images of checks that were erroneously rejected by a check deposit application.

8. The method of claim 1 further comprising, when the success status of the simulated remote check deposit is negative:
generating a recommended update for the remote check deposit application, wherein said update is based on the configuration parameters associated with the test file that resulted in the negative success status;
applying the recommended update; and
after application of the recommended update, re-simulating the remote check deposit at the remote check deposit application.

9. The method of claim 1 wherein the image files in the test file set are in jpg file format.

10. The method of claim 1 wherein the runtime test module comprises an Appium testing tool.

11. An automated remote check deposit testing system, the system comprising:
a check generation module comprising a processor and computer executable instructions stored in a non-transitory memory that, when run on the processor, are configured to:
receive a plurality of configuration parameters;
generate a test file set comprising a first image file representing a scanned image of a check front and a second image file representing a scanned image of a check back;
convert the test file set to a base 64 encoded string; and
transmit the base 64 encoded string to a runtime test module to simulate a remote check deposit at a remote check deposit application, wherein, to simulate the remote check deposit at the remote check deposit application, the runtime test module is configured to:
initialize the remote check deposit application;
provide deposit details requested by the remote check deposit application; and
transmit the base 64 encoded string to the remote check deposit application;
wherein the system is further configured to:
determine a success status of the simulated remote check deposit;
compile a test report based on the success status; and
automatically display, on a computer display associated with an administrator of the system, a graphical representation of the configuration parameters in conjunction with the test report.

12. The system of claim 11 wherein the configuration parameters comprise numerical check amount, text-based check amount, depositor name, deposit recipient, routing number, and account number.

13. The system of claim 11 wherein the configuration parameters comprise check type, and wherein check type is selected from a list comprising handwritten personal check, cashier's check, certified check, and traveler's check.

14. The system of claim 11 wherein the configuration parameters comprise check quality, and wherein:
check quality comprises a check scan quality that comprises a blurriness index and a positioning index, wherein the positioning index comprises a distance, rotation, and tilt; and
when the test file set simulates a handwritten check, check quality comprises a handwriting quality.

15. The system of claim 11 wherein the configuration parameters comprise a deposit endorsement, wherein the deposit endorsement parameter comprises:
a position and quality of an endorsement signature of an endorsement;
whether a name in the endorsement signature matches a depositor name; and
whether the endorsement includes a remote deposit indicator.

16. The system of claim 11 wherein the check generation module comprises an artificial intelligence (AI) model that is configured to generate the test file set based on the configuration parameters.

17. The system of claim 16 wherein the AI model is trained on a set of test data that includes historical images of checks that were erroneously rejected by a check deposit application.

18. The system of claim 11 further configured, when the success status of the simulated remote check deposit is negative, to:
generate a recommended update for the remote check deposit application, wherein said update is based on the configuration parameters associated with the test file that resulted in the negative success status;
apply the recommended update; and
after application of the recommended update, re-simulate the remote check deposit at the remote check deposit application.

19. The system of claim 11 wherein the image files in the test file set are in jpg file format.

20. The system of claim 11 wherein the runtime test module comprises an Appium testing tool.
